(19) United States
(12) Patent Application Publication
(10) Pub. No.: US 2008/0057814 A1
(43) Pub. Date: Mar. 6, 2008

(54) ADHESIVE FILM AND METHOD FOR BONDING FOAMS AND FABRICS

(75) Inventors: Steven E. Adams, Chester, VA (US); Gary A. Groat, Richmond, VA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: WORTHEN INDUSTRIES, Nashua, NH (US)

(21) Appl. No.: 11/847,026

(22) Filed: Aug. 29, 2007

Related U.S. Application Data
(60) Provisional application No. 60/823,843, filed on Aug. 29, 2006.

(51) Int. Cl. B32B 37/00; B32B 3/26; B32B 5/18; B32B 5/24

(52) U.S. Cl. 442/221; 156/60; 428/304.4; 442/370

(57) ABSTRACT

A laminate may comprise a first and at least a second substrate layer. The first substrate layer may include a layer of foam and the second substrate layer may include a foam layer, plastic layer, and/or fabric layer. A heat sealable adhesive layer may bond at least a portion of the first substrate layer to the second substrate layer. A method of making a laminate may comprise providing a first substrate layer comprising a first foam layer, providing at least a second substrate layer, providing a heat sealable adhesive layer between at least a portion of the first substrate layer and the second substrate layer, and heating at least one of the first substrate layer, the second substrate layer, or the heat sealable adhesive layer to bond the first substrate layer, the second substrate layer and the heat sealable adhesive layer. The heating may be provided either directly and/or indirectly.

### CROSS-REFERENCE TO RELATED APPLICATIONS

This application claims the benefit of U.S. Provisional Application Ser. No. 60/823,843, filed Aug. 29, 2006, the teachings of which are incorporated herein by reference.

### FIELD

The present disclosure relates to adhesive films and methods for bonding foams and fabrics.

### BACKGROUND

Foam is commonly found in many common household, industrial, and automotive articles such as, but not limited to, mattresses, furniture, cushions, and the like. During the manufacturing of these products, two or more pieces of foam may be joined to form a single, unitary structure. For example, many mattresses and furniture pieces feature multiple layers of foam having varying rigidities resulting in a product having a desired amount of support and softness.

Foam pieces may be joined using liquid adhesives that may be applied to one or more surfaces of the foam pieces by way of roll coating or spraying. The liquid adhesives may be either water-based or solvent-based adhesives. While the solvent-based adhesives may generally be easier to use by virtue of their inherent wet-tack compared to water-based adhesives, there has been a move away from the solvent-based adhesives for a variety of health and environmental reasons. Whether water-based or solvent-based liquid adhesives are used, once the liquid adhesive is applied to the foam pieces, the liquid adhesive should be allowed to dry, often for a period of between 4 to 24 hours, before the manufacturing process can be continued and article can be packaged and shipped.

If the liquid adhesive is not allowed to properly dry, the foam pieces may come apart under the stresses applied to the foam pieces during the manufacturing, packaging, or shipment processes. Additionally, if the liquid adhesives are not allowed to properly dry, the wet adhesive on the foam pieces may collect on processing equipment, such as conveyors or the blades used to cut and trim the foam pieces and may eventually gum-up the processing equipment necessitating halting the manufacturing process. Moreover, if the foam pieces are packaged prior to liquid adhesive properly drying, evaporating solvents from the solvent-based liquid adhesives may collect within the packaging causing a residual odor in the final product. Alternatively, if water-based adhesives are used, moisture may become trapped within the packaging causing mold and/or mildew growth.

The drying period, however, may be generally considered a bottleneck in the overall manufacturing process. For example, a significant amount of manufacturing space may be required to store and/or handle the product, particularly during the manufacturing of mattresses due to their large size. Additionally, the drying time may require a significant amount of coordination. Each article may be identified and recorded so that once the article has dried, the article can be reintroduced into the manufacturing process to allow the manufacturing process to continue. Moreover, the bonding of multiple layers of foam may require multiple drying periods, further complicating the manufacturing process.

Liquid adhesives may be difficult for operators to apply consistently across the surfaces with the desired thickness because many liquid adhesives are naturally generally clear. While colorants may be added to the liquid adhesives to make them more easily seen by the operator, the colorant may cause a colored spray line which may be seen through the materials to which it has been applied, even after the adhesive has dried. The colored spray line may be mistaken for an imperfection or evidence of mold/mildew growth by the end-user. Additionally, the colorant may bleed through the materials, especially if the materials become wet, such as in the furniture and mattress industry where the possibility of the product becoming wet is significant. In either case, the colorant may result in an undesirable appearance to the end-user.

Hot melt lamination may also be used to join foam pieces. However, hot melts may have a tendency to fail over time in foam laminating and as a result, some consider hot melts to have a poor reputation for foam lamination. Hot melt foam laminates may fail due, at least in part, to the difficulty in to wetting both surfaces of the foam with an adequate amount of heat to effect proper bonding. The difficulty in wetting the foam surfaces may be due, in part, to the large size of the foam pieces and the difficulty in laminating the foam pieces quickly enough to prevent the hot melt adhesive from cooling before bonding. Additionally, hot melts may generally have poor heat and moisture resistance and may tend to fail when exposed to heat in trucks when shipping, or to moisture such as bodily fluids. Hot melt foam lamination may be generally expensive due to the significant amount of heat from energy and the mass of adhesive required to create the bond. Finally, the hot melt process presents safety concerns that may be unacceptable in the manufacturing environment from burn hazards associated with heated adhesive and application equipment.

It is important to note that the present disclosure is not intended to be limited to a system or method which must satisfy one or more of any stated objects or features of the disclosure. It is also important to note that the present disclosure is not limited to the preferred, exemplary, or primary embodiment(s) described herein. Modifications and substitutions by one of ordinary skill in the art are considered to be within the scope of the present disclosure, which is not to be limited except by the following claims.

### BRIEF DESCRIPTION OF THE DRAWINGS

These and other features and advantages of the present disclosure will be better understood by reading the following detailed description, taken together with the drawings wherein:

FIG. 1 is a cross-sectional view of one embodiment of a foam-to-foam laminate according to the present disclosure;

FIG. 2 is a cross-sectional view of one embodiment of a foam-to-fabric or foam-to-plastic laminate according to the present disclosure;

FIG. 3 is a schematic block diagram of one embodiment of a manufacturing system for creating the foam-to-foam laminate shown in FIG. 1 according to the present disclosure; and

FIG. 4 is a schematic block diagram of one embodiment of a manufacturing system for creating the foam-to-fabric or foam-to-plastic laminate shown in FIG. 2 according to the present disclosure.

### DESCRIPTION

According to one embodiment, the present disclosure may feature a system and method of laminating two or more substrates together using a heat sealable film wherein at least one of the substrates may include foam and the other substrates may include foam and/or fabric or plastic. The system and method for laminating may be used for a variety of applications including, but not limited to, the production of mattresses and furniture.

Referring specifically to FIG. 1, a cross-sectional view of one embodiment of a foam-to-foam laminate 10 is shown. The foam-to-foam laminate 10 may include a first and at least a second layer of foam 12, 14 bonded together with a heat sealable film 16. While two layers of foam 12, 14 are shown bonded to a single layer of a heat sealable film 16, the laminate 10 may include three or more layers of foam bonded to a single layer of heat sealable film 16 as well as multiple layers of the heat sealable film 16.

The foam layers 12, 14 may be the same or different. For example, the foam layers 12, 14 may include, but are not limited to, open and/or closed cell foams, polystyrene foam, polyurethane foam, latex foam (both natural as well as synthetic latex), polymethacrylimide foam, polyvinylchloride foam, polypropylene foam, polyethylene foam, polystyrene foam (including expanded or extruded foam), as well as other foams. The foam layers 12, 14 may include viscoelastic or memory foams as well as foams having different density, firmness or softness (i.e., Indention Load Deflection), or other properties. The foam layers 12, 14 may have various thicknesses depending on the intended application. For example, the foam layers 12, 14 may have a thickness of approximately 0.5 to approximately 10 inches when used in mattresses and approximately 0.5 to approximately 5 inches when used in furniture.

A heat sealable film 16 may be disposed or otherwise placed between at least a portion of the foam layers 12, 14 and may contact at least a portion of the surfaces 18, 20 of the foams layers 12, 14. While the heat sealable film 16 is shown substantially co-extensive with the surfaces 18, 20 of the foam layers 12, 14, the heat sealable film 16 may only contact a portion of one or more of the surfaces 18, 20 of the foam layers 12, 14. As discussed above, while a single layer of a heat sealable film 16 is shown bonded to two layers of foam 12, 14, the laminate 10 may include multiple layers of heat sealable film 16. Additionally, a single layer of heat sealable film 16 may be bonded to more than two layers of foam 12, 14.

The heat sealable film 16 may include any thermoset or thermoplastic materials having sufficient adhesion to the foam layers 12, 14. For example, the heat sealable film 16 may include urethane, polyethylenes, polypropylenes, ethylene acrylic acids, ethylene vinyl acetate, polyester, and blends. Heat sealable adhesives may be compounded to achieve specific sealing requirements. The films may be provided in thicknesses of 0.5 to 10 mils in rolls and may be coated on release paper or film to protect the film from bonding to itself. Release paper or film may also serve as a carrier web for a film that is too light weight and elastic to be handled directly. Heat sealable films may be clear, though some may appear cloudy or hazy. The heat sealable films may also be pigmented to a specific color. Films may be extruded as continuous layers, or they can be designed to be extruded in patterns or as nonwovens.

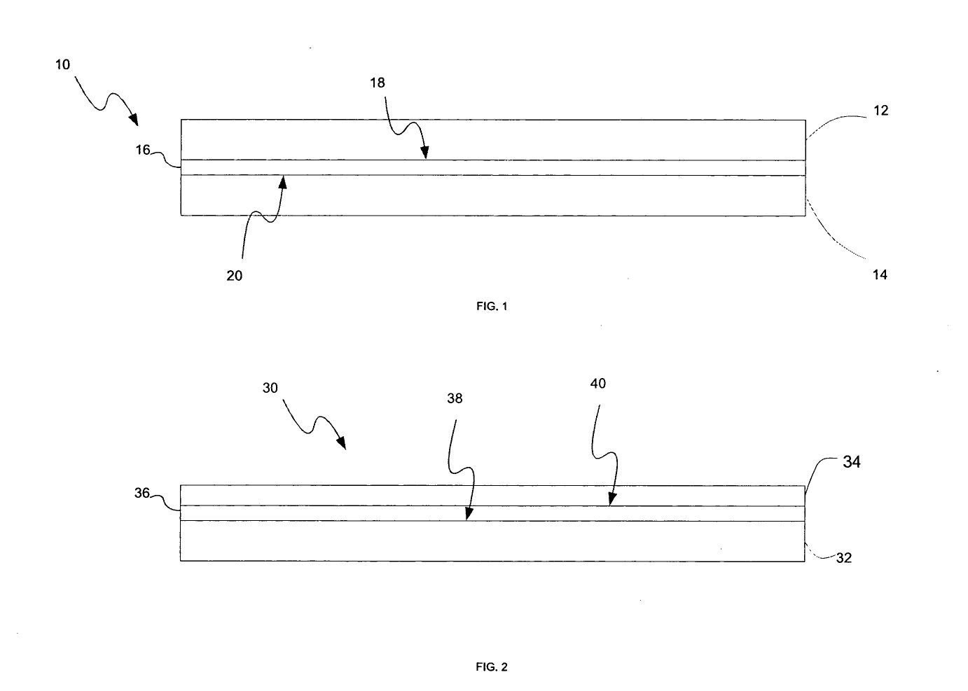

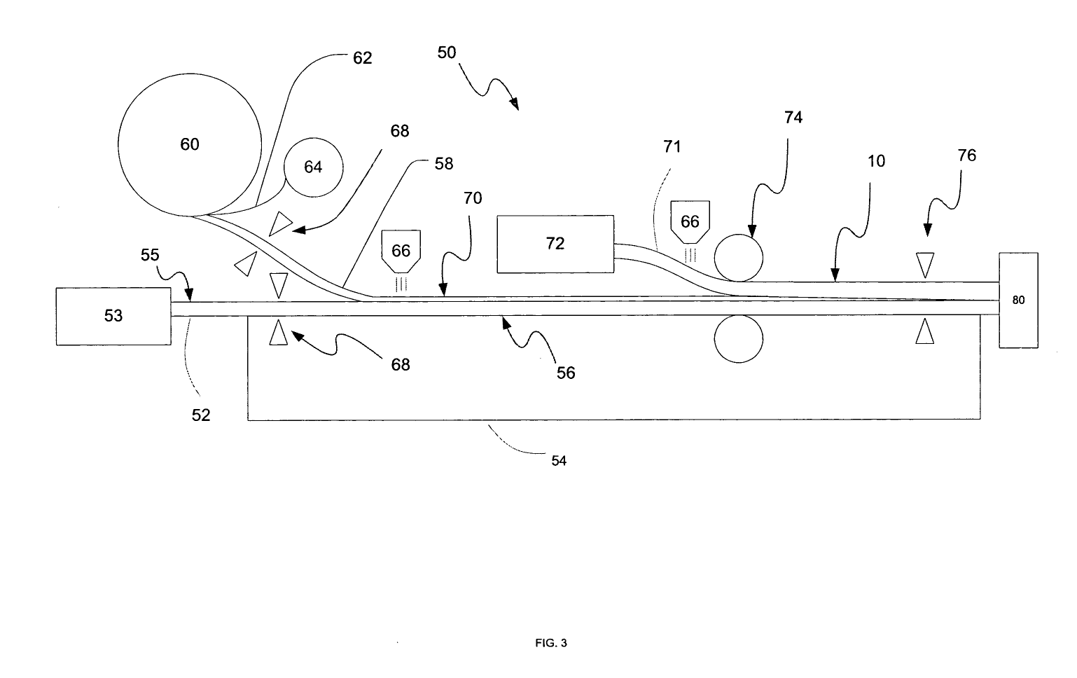

Referring to FIG. 2, a cross-sectional view of a foam-to-fabric or foam-to-plastic laminate 30 is shown. The foam-to-fabric laminate 30 may feature one or more layers of foam 32 and at least one layer of plastic or fabric 34 bonded together by at least one layer of heat sealable film 36. While a single foam layer 32 is shown, the laminate 30 may include two or more layers of foam 32 such as, but not limited to, two or more side-by-side layers of foam. The foam layer 32 may include any of the foam layers discussed above.

The foam-to-fabric laminate 30 may also include one or more layers of plastic or fabric 34. The fabric layer 34 may include either woven or non-woven materials which may be either natural (such as, but not limited to, cotton, leather, or the like) or synthetic. For example, the fabric layer 34 may include a fire-retardant material, an allergy resistant material, an anti-fungal or anti-bacterial resistant material, and/or liquid resistant material. The fabric layer 34 may also be quilted. Examples of plastics 34 may include polyethylene, polypropylene, vinyl, rubber, or urethane, which may include a single layer, multiple layers, or combinations. For example, the laminate 30 may include mattress or furniture cushions including an air bladder.

A layer of heat sealable film 36 may be bonded to the surfaces 38, 40 of the foam layer 32 and fabric or plastic layer 34. While the heat sealable film 36 is shown substantially coextensive with the surfaces 38, 40 of the foam layer 32 and fabric or plastic layer 34, the heat sealable film 36 may only contact a portion of the surfaces 38, 40 of the foam layer 32 and/or the fabric or plastic layer 34.

The heat sealable film 36 may include any thermoset or thermoplastic materials having sufficient adhesion to the foam layer 32 and the fabric or plastic layer 34. For example, the heat sealable film 16 may include urethane, polyethylenes, polypropylenes, ethylene acrylic acids, ethylene vinyl acetate, polyester, and blends. Heat sealable adhesives may be compounded to achieve specific sealing requirements. The films may be provided in thicknesses of 0.5 to 10 mils in rolls and may be coated on release paper or film to protect the film from bonding to itself. Release paper or film may also serve as a carrier web for a film that is too light weight and elastic to be handled directly. Heat sealable films may be clear, though some may appear cloudy or hazy. The heat sealable films may also be pigmented to a specific color. Films may be extruded as continuous layers, or they can be designed to be extruded in patterns or as nonwovens.

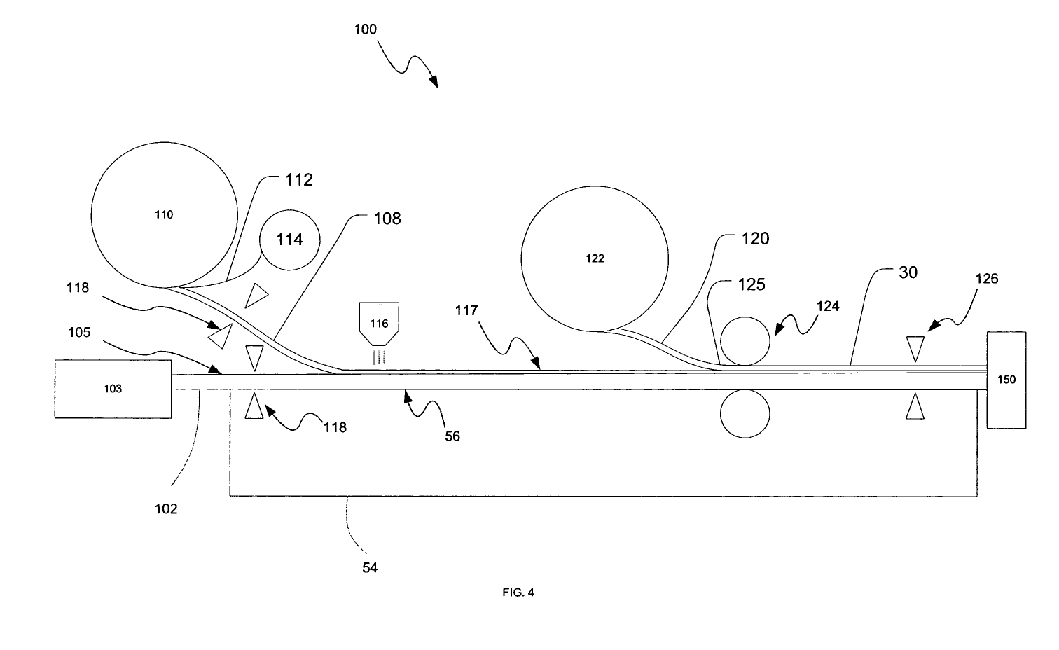

Referring specifically to FIG. 3, a schematic view of one embodiment of a manufacturing system 50 for manufacturing foam-to-foam laminates 10 is shown. A first layer of foam 52 may be feed onto a support frame 54, for example having a conveying surface 56 such as, but not limited to, a conveyor belt or the like. While the system 50 will be described with respect to a substantially horizontal system 50, the system 50 may also include a substantially vertical system 50. For example, a vertical system 50 may allow the edges of the components to line up as they slide to rest at the base of a press as it slowly moves from horizontal to vertical, effectively using the edge of the press as a guide, then are pressed together as the press comes together vertically. The speed of the conveying surface 56 may be adjusted.

The first layer of foam 52 may be manufactured substantially contemporaneously with the manufacture of the foam-to-foam laminate 10 and may be provided from an extruder, expansion molding apparatus, or any other device/system 53 for manufacturing the foam 52. Alternatively, the foam 52 may be manufactured separately from the manufacture of the foam-to-foam laminate 10, for example the foam 52 may be wound and provide in roll form or provided in large, flat sections. It should be noted that additional layers of foam 52 may also be placed onto the conveying surface 56 of the support frame 54 in addition to the single layer of foam as shown. The additional layers of foam may be placed substantially adjacently in a side-by-side like manner.

A layer of a heat sealable adhesive film 58 may be placed onto a surface 55 of the first layer of foam 52 which is moving along the conveying surface 56 of the support frame 54. As mentioned above, while a single layer of foam 52 is shown on the conveying surface 56, more than one piece of foam may be placed onto the conveying surface at the same time and the heat sealable adhesive film 58 may be placed on one or more of the surfaces 55 of these pieces of foam.

The heat sealable adhesive film 58 may be manufactured substantially contemporaneously with the manufacture of the foam-to-foam laminate 10. Alternatively, the heat sealable adhesive film 58 is manufactured separately from the manufacture of the foam-to-foam laminate 10; for example, the heat sealable adhesive film 58 may be unwound from a roll 60. The unrolling of adhesive film 58 may include movement along the first foam layer 52, in effect augmenting or replacing the movement of conveyor 56 on frame 54. The heat sealable adhesive film 58 optionally includes a release layer or backing 62 which may be removed from the heat sealable adhesive film 58 and wound onto another roll 64.

A second layer of foam 71 may also placed onto the surface 70 of the heat sealable adhesive film 58. The second layer of foam 71 may be manufactured substantially contemporaneously with the manufacture of the foam-to-foam laminate 10 and may be provided from an extruder, expansion molding apparatus, or any other device/system 72 for manufacturing the foam 52. Alternatively, the foam 71 may be manufactured separately from the manufacture of the foam-to-foam laminate 10, for example the foam 71 may be wound and provide in roll form or provided in large, flat sections. It should be noted that additional layers of foam 71 may also be placed onto the surface 70 of the heat sealable adhesive film 58 in addition to the single layer of foam as shown.

One or more of the layers 52, 58, and/or 71 may be directly heated prior to passing through a press 74. As used herein, direct heating may include, for example, one or more heaters 66 (such as, but not limited to, electric heaters, fuel heaters (for example, but not limited to, gas, oil, or the like), infrared heater or lamps, electromagnetic radiation heaters, induction heaters, or the like to heat one or more of the first layer of foam 52, the second layer of foam 71, and/or the heat sealable adhesive film 58 sufficiently to cause the heat sealable adhesive film 58 to bond to at least one of the surfaces of the first and/or second foam layers 52, 71. For example, a heater 66 may apply heat substantially only to the heat sealable adhesive film 58 and/or may apply heat substantially only to the first and/or second foam layers 52, 71. Additionally, one or more of the layers 52, 58, and/or 71 may be directly heated, at least in part, by applying a reactive chemical to one or more of the layers 52, 58, and/or 71. The reactive chemical may be activated, for example, by radio frequency transmission or the like.

One or more of the layers 52, 58, and/or 71 may also be indirectly heated prior to passing through a press 74. As used herein, indirect heating may include the heat involved in the manufacturing of one or more of the layers 52, 58, and/or 71 substantially contemporaneously with the lamination process and providing the substantially contemporaneously manufactured layer(s) at a temperature sufficient to cause the heat sealable adhesive film 58 to bond to at least one of the foam layers 52, 71 when placed in contact without adding any additional heat. For example, at least one of the first and/or second layers of foam 52, 71 may be substantially contemporaneously manufactured with the lamination process and provided to the lamination process at a temperature sufficient to cause the heat sealable adhesive film 58 to bond to at least one of the foam layers 52, 71 when placed in contact. Alternatively (or in addition), the heat sealable adhesive film 58 may be manufactured substantially contemporaneously with the lamination process and provided to the lamination process at a temperature sufficient to cause the heat sealable adhesive film 58 to bond to at least one of the foam layers 52, 71 when placed in contact. The lamination process may also include both direct and indirect heating.

Cutters 68, 76 may optionally cut and/or trim the first and/or second layers of foam 52, 71 and/or the heat sealable adhesive film 58. As mentioned above, the combination of the first and second layers of foam 52, 71 and the heat sealable adhesive film 58 may be feed through a press 74. The press 74 may apply a compressive force against the combination of the first and second layers of foam 52, 71 and the heat sealable adhesive film 58 to facilitate bonding the first and second layers of foam 52, 71 to the heat sealable adhesive film 58 to form the laminate 10.

The laminate 10 may be ready substantially immediately for further processing at devices 80. For example, additional layers of either foam or fabric may be substantially immediately added to the laminate 10 and the laminate 10 may be substantially immediately ready for cutting, trimming, handling, packaging, and shipping or the like.

According to another embodiment shown in FIG. 4, a schematic view of one embodiment of a system 100 for manufacturing foam-to-fabric or foam-to plastic laminates 30 is shown. A layer of foam 102 may be feed onto a support frame 54, for example, having a conveying surface 56 as described above. The layer of foam 102 may be manufactured substantially contemporaneously with the manufacture of the foam-to-fabric laminate 30 from a device 103 or may be manufactured separately from the manufacture of the foam-to-fabric laminate 30. It should be noted that additional layers of foam 102 may also be placed onto the conveying surface 56 of the support frame 54 in addition to the single layer of foam as shown.

A layer of a heat sealable adhesive film 108 may be placed onto a surface 105 of the first layer of foam 102 which may be moving along the conveying surface 56 of the support frame 54. As mentioned above, while a single layer of foam 102 is shown on the conveying surface 56, more than one piece of foam may be placed onto the conveying surface 56 at the same time and the heat sealable adhesive film 108 may be placed on one or more of the surfaces 105 of these pieces of foam.

The heat sealable adhesive film 108 may be manufactured substantially contemporaneously with the manufacture of the foam-to-fabric or foam to plastic laminate 30. Alternatively, the heat sealable adhesive film 108 may be manufactured separately from the manufacture of the foam-to-fabric or foam to plastic laminate 30; for example, the heat sealable adhesive film 108 may be unwound from a roll 110. The heat sealable adhesive film 108 may optionally include a release layer or backing 112 which may be removed from the heat sealable adhesive film 108 and wound onto another roll 114.

One or more layers of fabric or plastic 120 may be placed onto the surface 117 of the heat sealable adhesive film 108. The fabric or plastic 120 may be manufactured substantially contemporaneously with the manufacture of the foam-to-fabric or plastic laminate 30, but is preferably unwound from a roll 122. It should be noted that additional layers of fabric or plastic 120 may also be placed onto the surface 117 of the heat sealable adhesive film 108 in addition to the single layer of fabric or plastic 120 as shown. Additionally, while the process has been described in which the heat sealable adhesive film 108 is first applied to the layer of foam 102, the heat sealable adhesive film 108 may be first applied to the layer of fabric or plastic 120 or may be substantially contemporaneously applied to layer of foam 102 and the layer of fabric or plastic 120. As mentioned previously, the unrolling of adhesive layer 108 from roll 110 and secondary layer 120 from roll 122 may include movement along the first foam layer 52, in effect augmenting or replacing the movement of conveyor 56 on frame 54.

One or more of the layers 102, 108, and/or 120 may be directly heated prior to passing through a press 124. As used herein, direct heating may include, for example, one or more heaters 116 (such as, but not limited to, electric heaters, fuel heaters (for example, but not limited to, gas, oil, or the like), infrared heater or lamps, electromagnetic radiation heaters, induction heaters, or the like to heat one or more of the first layer of foam 102, the fabric 120, and/or the heat sealable adhesive film 108 sufficiently to cause the heat sealable adhesive film 108 to bond to at least one of the surfaces of the foam layer 102 and/or fabric layer 120. For example, a heater 116 may apply heat substantially only to the heat sealable adhesive film 108 and/or may apply heat substantially only to the first foam layer 102 and/or the fabric 120. Additionally, one or more of the layers 102, 108, and/or 120 may be directly heated, at least in part, by applying a reactive chemical to one or more of the layers 102, 108, and/or 120. The reactive chemical may be activated, for example, by radio frequency transmission or the like.

One or more of the layers 102, 108, and/or 120 may also be indirectly heated prior to passing through a press 124. As used herein, indirect heating may include manufacturing one or more of the layers 102, 108, and/or 120 substantially contemporaneously with the lamination process and providing the substantially contemporaneously manufactured layer(s) at a temperature sufficient to cause the heat sealable adhesive film 108 to bond to at least one of the first foam layer 102 and/or the fabric layer 120 when placed in contact without adding any additional heat. For example, at least one of the first foam layer 102 and/or fabric layer 120 may be substantially contemporaneously manufactured with the lamination process and provided to the lamination process at a temperature sufficient to cause the heat sealable adhesive film 108 to bond to at least one of the first foam layer 102 and/or fabric layer 120 when placed in contact. Alternatively (or in addition), the heat sealable adhesive film 108 may be manufactured substantially contemporaneously with the lamination process and provided to the lamination process at a temperature sufficient to cause the heat sealable adhesive film 108 to bond to at least one of the first foam layer 102 and/or fabric layer 120 when placed in contact. The lamination process may also include both direct and indirect heating.

Cutters 118, 126 may optionally cut and/or trim the first layer of foam 102 and/or fabric 120 and/or the heat sealable adhesive film 105. As mentioned above, the combination 125 of the foam layer 102, the fabric 120, and the heat sealable adhesive film 108 may be feed through a press 124. The press 124 may apply a compressive force against the combination 125 of the foam layer 102, the fabric 120, and the heat sealable adhesive film 108 to facilitate bonding the first layer of foam 102 and fabric 120 to the heat sealable adhesive film 108 to form the laminate 30.

The laminate according to the present disclosure may include a heat sealable film provided as a one-piece, unitary layer having a predetermined thickness prior to its application to the foam layer(s) and/or the fabric or plastic layer and may be applied to the surface of the foam layer(s) and/or the fabric or plastic layer(s) in a single step. As a result, the heat sealable adhesive film may eliminate the need to add a colorant to the heat sealable adhesive film as well as the issues associated with a colorant as discussed above.

Additionally, the laminate and heat sealable film may substantially eliminate the drying associated with the liquid adhesives and reduce the manufacturing bottleneck associated with the drying process. For example, the build-up of adhesive on the cutting blades may be reduced and the time to allow the adhesive to develop a sufficiently strong bond for handling and further processing may be reduced. The laminate may also substantially eliminate the issues of mold/bacteria growth associated with water-based liquid adhesives or retention of solvent odors in packaging.

Additionally, heat sealable adhesive films may be formulated having excellent heat and moisture resistance, and therefore may be resistant to failure when subjected to bodily fluids such as perspiration or urine. Finally, the lamination process may reduce the amount of heat/energy necessary compared to hot melts.

In summary, according to one aspect, the present disclosure may feature a laminate comprising a first and at least a second substrate layer in which at least the first substrate layer may include a layer of foam. A heat sealable adhesive layer may bond at least a portion of the first substrate layer to the second substrate layer.

According to another aspect, the present disclosure may feature a method of making a laminate comprising providing a first substrate layer comprising a first foam layer, providing at least a second substrate layer, providing a heat sealable adhesive layer between at least a portion of the first substrate layer and the second substrate layer, and heating at least one of the first substrate layer, the second substrate layer, or the heat sealable adhesive layer to bond the first substrate layer, the second substrate layer and the heat sealable adhesive layer. The heating may be provided either directly and/or indirectly. Additionally, the first substrate layer, the second substrate layer and the heat sealable adhesive layer may be compressed after heating.

According to yet another aspect, the present disclosure may feature a laminate comprising a layer of foam, a layer of nonwoven material, and a heat sealable adhesive layer. The heat sealable adhesive layer may contact at least a portion of a surface of the layer of foam and a surface of the layer of nonwoven material and may be configured to bond the at least a portion of the layer of foam to the layer of nonwoven material.

As mentioned above, the present disclosure is not intended to be limited to a system or method which must satisfy one or more of any stated or implied object or feature of the disclosure and should not be limited to the preferred, exemplary, or primary embodiment(s) described herein. The foregoing description of a preferred embodiment of the disclosure has been presented for purposes of illustration and description. It is not intended to be exhaustive or to limit the disclosure to the precise form disclosed. Obvious modifications or variations are possible in light of the above teachings. The embodiment was chosen and described to provide the best illustration of the principles of the disclosure and its practical application to thereby enable one of ordinary skill in the art to utilize the disclosure in various embodiments and with various modifications as is suited to the particular use contemplated. All such modifications and variations are within the scope of the disclosure as determined by the claims when interpreted in accordance with breadth to which they are fairly, legally and equitably entitled.

What is claimed is:

1. A laminate comprising:
a first and at least a second substrate layer, wherein at least said first substrate layer includes a layer of foam; and
a heat sealable adhesive layer bonding at least a portion of said first substrate layer to said at least a second substrate layer.

2. The laminate of claim 1, wherein said at least a second layer comprises a foam layer.

3. The laminate of claim 1, wherein said at least a second layer comprises a plastic layer.

4. The laminate of claim 1, wherein said at least a second layer comprises a fabric layer.

5. The laminate of claim 4, wherein said fabric layer comprises a nonwoven material.

6. The laminate of claim 4, wherein said fabric layer comprises a woven material.

7. The laminate of claim 1, wherein said heat sealable adhesive layer comprises a thermoset material.

8. The laminate of claim 1, wherein said heat sealable adhesive layer comprises a thermoplastic material.

9. The laminate of claim 1, wherein said heat sealable adhesive layer comprises at least one chosen from the group consisting of polyurethane, polyethylene, polypropylenes, ethylene acrylic acids, ethylene vinyl acetate, polyester, and blends thereof.

10. A method of making a laminate comprising:
providing a first substrate layer, said first substrate layer comprising a first foam layer;
providing at least a second substrate layer;
providing a heat sealable adhesive layer between at least a portion of said first substrate layer and said at least a second substrate layer; and
heating at least one of said first substrate layer, said at least a second substrate layer, or said heat sealable adhesive layer to bond said first substrate layer, said at least a second substrate layer and said heat sealable adhesive layer.

11. The method of claim 10, further comprising compressing said first substrate layer, said at least a second substrate layer and said heat sealable adhesive layer after heating.

12. The method of claim 10, wherein said second at least a second layer comprises a foam layer.

13. The method of claim 10, wherein said at least a second layer comprises a plastic layer.

14. The method of claim 10, wherein said at least a second layer comprises a fabric layer.

15. The method of claim 14, wherein said fabric layer comprises a nonwoven material.

16. The method of claim 14, wherein said fabric layer comprises a woven material.

17. The method of claim 10, wherein said heat sealable adhesive layer comprises a thermoset material.

18. The method of claim 10, wherein said heat sealable adhesive layer comprises a thermoplastic material.

19. The method of claim 10, wherein said heat sealable adhesive layer comprises at least one chosen from the group consisting of polyurethane, polyethylene, polypropylenes, ethylene acrylic acids, ethylene vinyl acetate, polyester, and blends thereof.

20. The method of claim 10, wherein heating said at least one of said first substrate layer, said at least a second substrate layer, or said heat sealable adhesive layer comprises indirectly heating said at least one of said first substrate layer, said at least a second substrate layer, or said heat sealable adhesive layer.

21. The method of claim 10, wherein heating said at least one of said first substrate layer, said at least a second substrate layer, or said heat sealable adhesive layer comprises directly heating said at least one of said first substrate layer, said at least a second substrate layer, or said heat sealable adhesive layer.

22. A laminate comprising:
a layer of foam;
a layer of nonwoven material; and
a heat sealable adhesive layer contacting at least a portion of a surface of said layer of foam and a surface of said layer of nonwoven material, said heat sealable adhesive layer configured to bond said at least a portion of said layer of foam to said layer of nonwoven material.
